(19) United States
(12) Patent Application Publication
(10) Pub. No.: US 2012/0102261 A1
(43) Pub. Date: Apr. 26, 2012

(54) Systems and Methods for Tiered Non-Volatile Storage

(76) Inventors: Harley Burger, San Jose, CA (US); Robert W. Warren, Loveland, CO (US); Shaohua Yang, Santa Clara, CA (US)

(21) Appl. No.: 13/126,746

(22) PCT Filed: Jul. 7, 2009
(86) PCT No.: PCT/US09/49752

§ 371 Date: Apr. 28, 2011

(51) Int. Cl. G06F 12/00

(52) U.S. Cl. 711/103; 711/E12.008

(57) ABSTRACT

Various embodiments of the present invention provide systems and methods for tiered non-volatile storage. As an example, a multi-tiered non-volatile storage device is disclosed that includes a hard disk storage; a solid state, non-volatile storage that caches a subset of data included on the hard disk storage; and a controller circuit that is operable to control data transfer between the solid state, non-volatile storage and the hard disk storage

### CROSS REFERENCE TO RELATED APPLICATIONS

The present application claims priority to (is a US National Phase Application of) PCT Patent Application No. PCT/US2009/049752 filed Jul. 7, 2009 and entitled SYSTEMS AND METHODS FOR TIERED NON-VOLATILE STORAGE. The entirety of the aforementioned reference is incorporated herein by reference for all purposes.

### BACKGROUND OF THE INVENTION

The present inventions are related to systems and methods for implementing storage devices, and more particularly to systems and methods for implementing storage devices having tiers of storage.

A hard disk drive is often designed to write data on a sector by sector basis. Thus, for example, a write to a hard disk drive may involve writing 4096 bytes during a given write process that is graphically depicted in FIG. 1. Following FIG. 1, a 512 byte set of data to be written to a hard disk drive is provided by a host (step A). In turn, the hard disk drive retrieves a 4096B data set 120 that includes the address space to be written 130 (step B). The hard disk drive overwrites the address space to be written with the data to be written 110, and subsequently writes the entire 4096 byte block back to the non-volatile memory (step C). Such a read/modify/write process allows for supporting the mismatch in the size of memory blocks supported by the host and the hard disk drive. However, such an approach incurs considerable latency in accessing the hard disk drive.

Hence, for at least the aforementioned reason, there exists a need in the art for advanced systems and methods for non-volatile storage.

### BRIEF SUMMARY OF THE INVENTION

The present inventions are related to systems and methods for implementing storage devices, and more particularly to systems and methods for implementing storage devices having tiers of storage.

Various embodiments of the present inventions provide multi-tiered non-volatile storage devices. Such devices include a hard disk storage, a solid state, non-volatile storage, and a controller circuit. The solid state, non-volatile storage caches a subset of data included on the hard disk storage, and the controller circuit is operable to control data transfer between the solid state, non-volatile storage and the hard disk storage. In some cases, the hard disk storage is at least an order of magnitude larger than the solid state, non-volatile storage. In some instances of the aforementioned embodiments, the hard disk storage may be either a single dimensional hard disk storage or a two dimensional hard disk storage. In other instances, the hard disk storage includes both a single dimensional hard disk storage and a two dimensional hard disk storage. In such instances, the single dimensional hard disk storage may cache a subset of data included on the two dimensional hard disk storage, and the controller circuit may be operable to control data transfer between the solid state, non-volatile storage and the hard disk storage. In particular cases, the two dimensional hard disk storage is three times larger than the single dimensional hard disk storage.

In other instances of the aforementioned embodiments, the controller circuit is operable to bypass the solid state, non-volatile storage when performing a multi-block transfer between a host and the hard disk storage. In some such instances, the device further includes a buffer that is operable to store a block of data from the hard disk storage, and to perform a series of sub-block transfers to a requesting host under control of the controller circuit. The buffer may also be operable to receive a series of sub-block transfers from a host, and to combine the sub-block transfers into a single block transfer to the hard disk storage under control of the controller circuit.

Other embodiments of the present invention provide methods for non-volatile data storage. Such methods include providing a multi-tiered, non-volatile memory with a hard disk storage; a solid state, non-volatile storage; and a controller circuit. The solid state, non-volatile storage caches a subset of data included on the hard disk storage, and the controller circuit is operable to control data transfer between the solid state, non-volatile storage and the hard disk storage. The methods further include receiving a request from a host to access the multi-tiered, non-volatile memory; and responding to the request.

In some cases, the request is a read request, and responding to the read request includes: determining whether the address space corresponding to the read request is included in the solid state, non-volatile storage; and where the address space corresponding to the read request is included in the solid state, non-volatile storage, responding to the read request from the solid state, non-volatile storage. In other cases, responding to the read request includes transferring a block of data from the hard disk storage to the solid state, non-volatile storage. The block of data includes the address space corresponding to the read request where the address space corresponding to the read request is not included in the solid state, non-volatile storage. The response also includes responding to the read request from the solid state, non-volatile storage.

In particular instances of the aforementioned embodiments, the request is an extended read request. In such instances, responding to the extended read request may include: determining whether the address space corresponding to the extended read request is included in the solid state, non-volatile storage; and where the address space corresponding to the read request is not included in the solid state, non-volatile storage, responding to the extended read request from the hard disk storage without passing through the solid state, non-volatile storage. In other instances where the address space corresponding to the read request is at least partially included in the solid state, non-volatile storage, responding to the extended read request by writing the address space corresponding to the extended read request from the solid state, non-volatile storage to the hard disk storage, and responding to the extended read request from the hard disk storage without passing through the solid state, non-volatile storage.

In other instances of the aforementioned embodiments, the request is a write request. In some such instance, responding to the read request includes determining whether the address space corresponding to the write request is included in the solid state, non-volatile storage; and where the address space corresponding to the write request is included in the solid state, non-volatile storage, responding to the write request by writing the data corresponding to the write request to the solid state, non-volatile storage. Alternatively, where the address space corresponding to the write request is not included in the solid state, non-volatile storage, responding includes transferring a block of data from the hard disk storage to the solid state, non-volatile storage. The block of data includes the address space corresponding to the write request. The response to the write request then includes writing the data corresponding to the write request to the solid state, non-volatile storage.

In particular instances of the aforementioned embodiment, the request is an extended write request. In such instances, responding to the extended write request includes: determining whether the address space corresponding to the extended write request is included in the solid state, non-volatile storage; and where the address space corresponding to the extended write request is not included in the solid state, non-volatile storage, responding to the extended write request by writing the data corresponding to the extended write request to the hard disk storage without passing through the solid state, non-volatile storage. In other cases, where the address space corresponding to the extended write request is at least partially included in the solid state, non-volatile storage, responding to the extended write request includes invalidating the address space corresponding to the extended write request in the solid state, non-volatile storage, and writing the data corresponding to the extended write request to the hard disk storage without passing through the solid state, non-volatile storage.

Yet other embodiments of the present invention provide non-volatile storage systems. Such non-volatile storage systems include a hard disk storage comprising a storage medium, and an interface controller circuit. The interface controller circuit is operable to control both single dimensional access to the storage medium and two dimensional access to the storage medium. The storage systems further include solid state non-volatile storage that caches a subset of data included on the hard disk storage, and a controller circuit that is operable to control data transfer between the solid state, non-volatile storage and the hard disk storage.

This summary provides only a general outline of some embodiments of the invention. Many other objects, features, advantages and other embodiments of the invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several figures to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 graphically depicts a read/modify/write approach used in the prior art to write blocks of data to a hard disk drive;

FIG. 2 shows a tiered non-volatile memory communicably coupled to a host in accordance with one or more embodiments of the present invention;

FIG. 3 shows another tiered non-volatile memory communicably coupled to a host in accordance with various embodiments of the present invention;

FIG. 4 shows yet another tiered non-volatile memory communicably coupled to a host in accordance with some embodiments of the present invention;

FIG. 5 graphically depicts a single dimensional track employed on a single dimensional hard disk storage device;

FIG. 6 graphically depicts multiple tracks employed on a two dimensional hard disk storage device in accordance with various embodiments of the present invention;

FIGS. 7a-7c graphically depicts a process of writing data to a two dimensional hard disk storage device in accordance with some embodiments of the present invention;

FIG. 8 shows a multi-tiered storage device in accordance with some embodiments of the present invention;

FIG. 9 is a flow diagram showing a method in accordance with some embodiments of the present invention for storing data in relation to a tiered non-volatile storage device; and

FIG. 10 is a flow diagram depicting a method in accordance with one or more embodiments of the present invention for bypassing an upper tier, solid state, non-volatile storage.

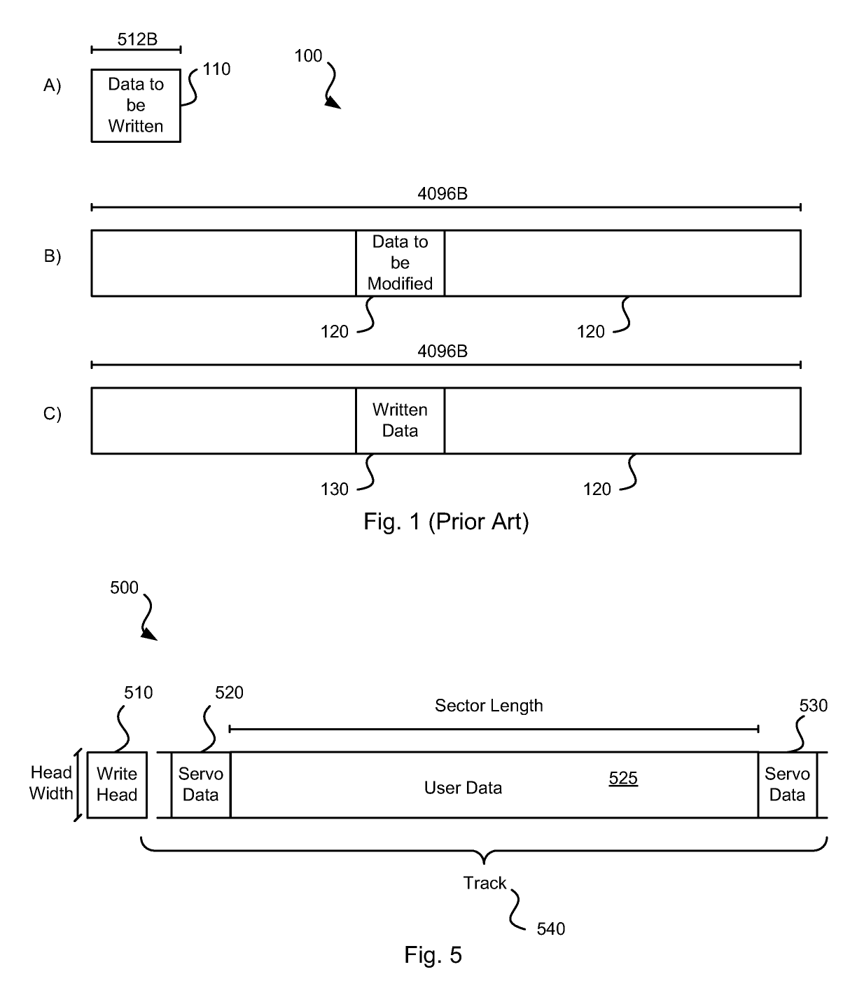

### DETAILED DESCRIPTION OF THE INVENTION

The present inventions are related to systems and methods for implementing storage devices, and more particularly to systems and methods for implementing storage devices having tiers of storage.

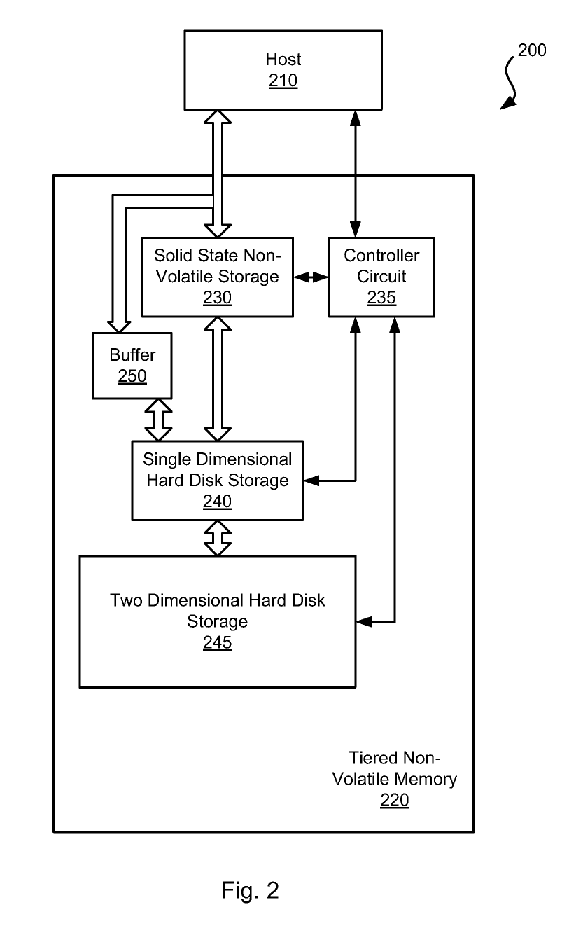

Turning to FIG. 2, a system 200 including a tiered non-volatile memory 220 communicably coupled to a host 210 is shown in accordance with one or more embodiments of the present invention. Host 210 may be any device or system capable of transferring data to and from a storage device. Thus, host 210 may be, but is not limited to, a microprocessor, a computer based system, or an interface circuit as are known in the art. Based upon the disclosure provided herein, one of ordinary skill in the art will recognize a variety of devices and/or systems that may serve as a host in accordance with different embodiments of the present invention.

Tiered non-volatile memory 220 includes three tiers of memory. Specifically, tiered non-volatile memory 220 includes a first tier comprising a solid state, non-volatile storage 230, a second tier comprising a single dimensional hard disk storage 240, and a third tier comprising a two dimensional hard disk storage 245. Solid state, non-volatile storage 230 may be implemented using any solid state memory technology known in the art. Thus, solid state, non-volatile storage 230 may be implemented using, but is not limited to, flash memory, phase change memory, spin-torque memory, ferroelectric memory, magnetic memory, resistive memory, racetrack memory, oxide trap based flash memory, or other non-volatile, solid state memory types known in the art. Solid state, non-volatile storage 230 provides the advantages of fast I/O access, along with other benefits of solid state devices including reduced power and reasonable reliability. Further, solid state, non-volatile storage 230 provides an ability to translate long and short memory accesses between host 210 and tiered non-volatile memory 220.

Single dimensional hard disk storage 240 is a hard disk where the track width is substantially the same width as a write head used for writing data from the disk. This is graphically depicted and described in greater detail in relation to FIG. 5 below. Single dimensional hard disk storage 240 may include relatively long sectors of data. Such sectors may be much longer than the access block supported by host 210. For example, such sectors may be 4096 bytes in length, whereas the access length supported by host 210 may only be 512 bytes. Further, single dimensional hard disk storage 240 typically offers lower cost per bit compared with solid state, non-volatile memories, but at increased access latency.

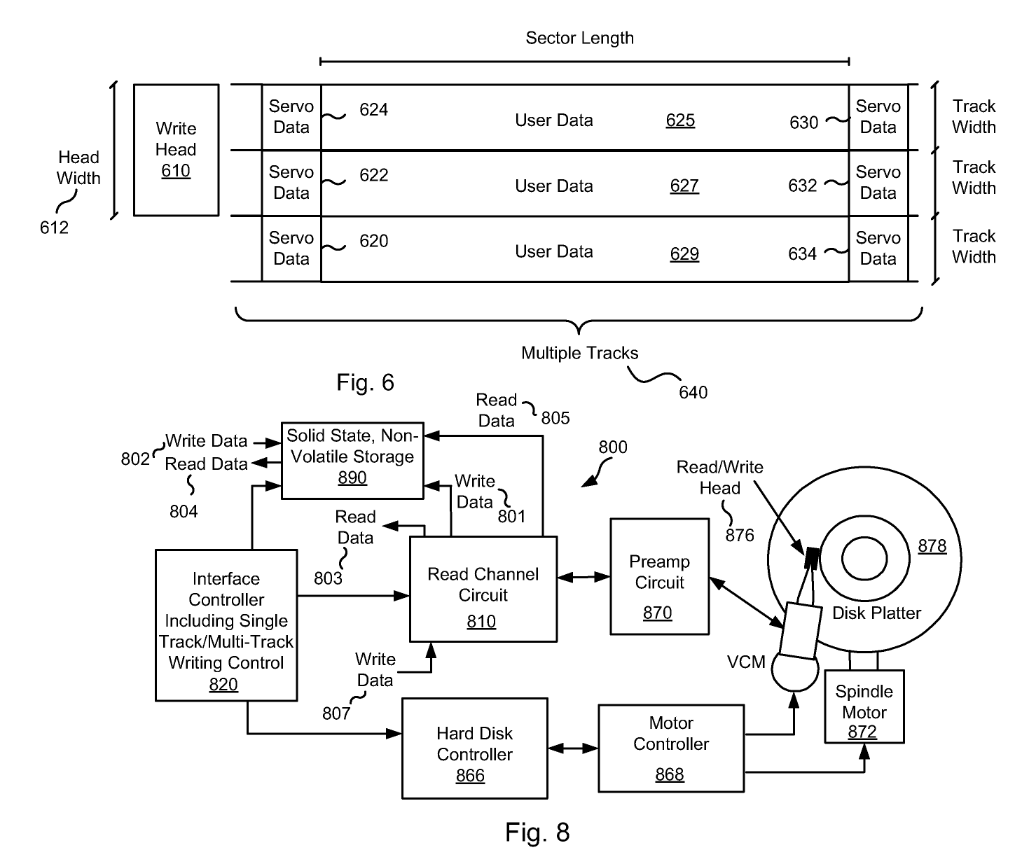

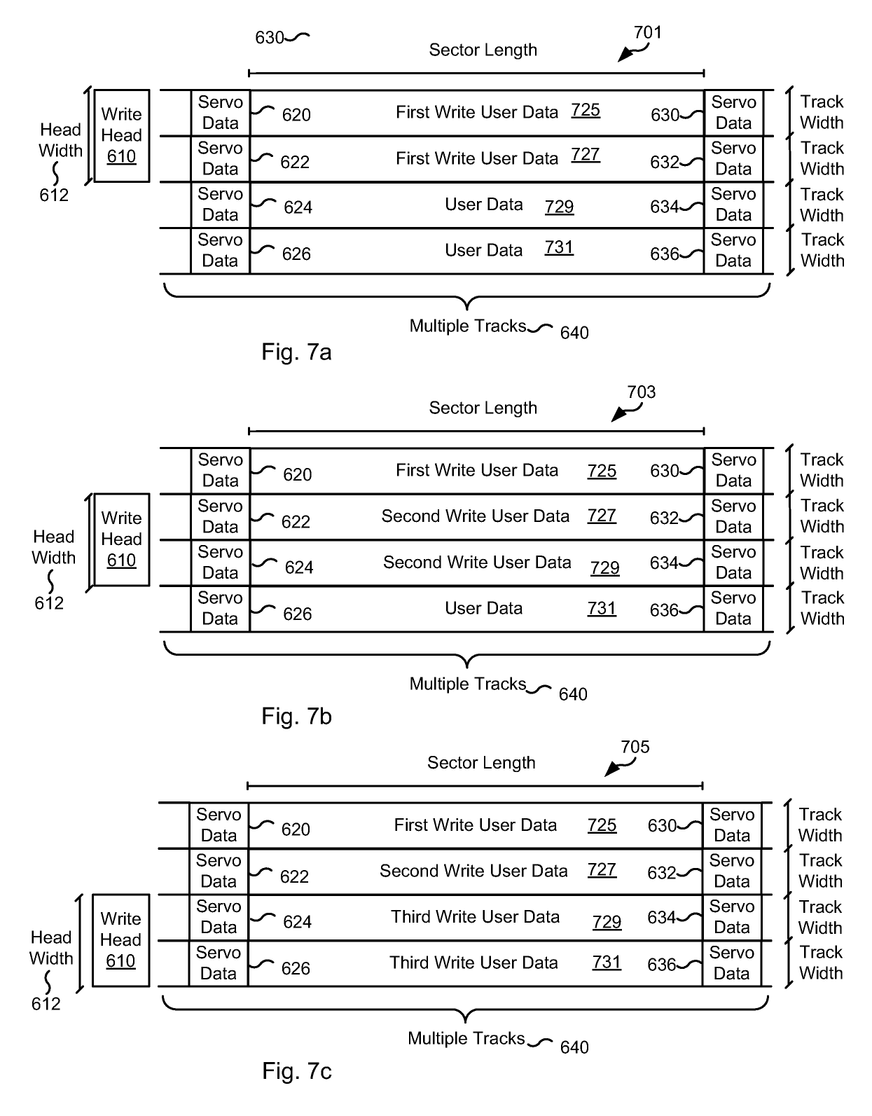

In contrast, two dimensional hard disk storage 245 is a hard disk where the track width is less than the width of a write head used for writing data from the disk. This is graphically depicted and described in greater detail in relation to FIGS. 6-7 below. By offering track widths that are less than the width a write width, two dimensional hard disk storage 245 can offer increased areal density, and as such decrease the cost per bit of storage. Such an approach generally relies on powerful codes that span multiple tracks. While offering increased bit density, relatively slow I/O rates are supported. However, these slow access times are hidden on average by the access through solid state, non-volatile storage 230 and single dimensional hard disk storage 240.

In some embodiments of the present invention, solid state, non-volatile storage 230 operates as a cache to single dimensional hard disk storage 240, and single dimensional hard disk storage 240 operates as a cache for two dimensional hard disk storage 245. Caching between each of the levels of cache is governed by a controller circuit 235. Such caching provides an advantage of being able to mask the latency of a read/modify/write instruction from host 210. Said another way, while a read/modify write process may in some cases still be performed between solid state, non-volatile storage 230 and single dimensional hard disk storage 240, and/or between single dimensional hard disk storage 240 and two dimensional hard disk storage 245, the latency caused by such a process is masked from host 210. Alternatively, in some cases solid state, non-volatile storage 230 may include entire sectors (or larger blocks of data) pulled from single dimensional hard disk storage 240, and allow for overwriting only a portion of a given sector. When solid state, non-volatile memory 230 is full and an address is accessed that is not included in solid state, non-volatile memory 230, a cache miss occurs. Such a cache miss causes a write back of at least a sector of data from solid state, non-volatile storage 230 to single dimensional hard disk storage 240 (or an invalidation of a sector of data in solid state, non-volatile storage 230), and a read of a sector of data from single dimensional hard disk storage 240 that includes the address to be accessed. Where the data including the address to be accessed is not included in single dimensional hard disk storage 240, another cache miss occurs. This cache miss causes a write back of at least a sector of data from single dimensional hard disk storage 240 to two dimensional hard disk storage 245 (or an invalidation of at least a sector of data in single dimensional hard disk storage 240), and a read of a sector of data from two dimensional hard disk storage 245 that includes the address to be accessed. It should be noted that any cache miss support approach and/or cache replacement scheme known in the art may be used to determine whether a cache miss has occurred, and to transfer data between different levels of the cache performing a cache replacement.

As just some other advantages, a lower active duty cycle for tiered non-volatile storage 220 may be used where a multi-level caching scheme is employed. Yet further, because the latency of the read/modify/write process is masked from host 210, the hard disks in single dimensional hard disk storage 240 may operate at a much lower rate of revolution.

In one particular embodiment of the present invention, single dimensional hard disk storage 240 is ten times larger than solid state, non-volatile storage 230, and two dimensional hard disk storage 245 is ten times larger than single dimensional hard disk storage 240. Based upon the disclosure provided herein, one of ordinary skill in the art will recognize a variety of different ratios between solid state, non-volatile storage 230, single dimensional hard disk storage 240, and/or two dimensional hard disk storage 245 that may be supported in accordance with different embodiments of the present invention. In one particular embodiment of the present invention, two dimensional hard disk storage 245 is two terabytes, one dimensional hard disk storage 240 is five gigabytes, and solid state, non-volatile storage 230 is fifty megabytes. Based upon the disclosure provided herein, one of ordinary skill in the art will recognize a variety of memory sizes that can be used for each of two dimensional hard disk storage, single dimensional hard disk storage, and solid state, non-volatile storage in accordance with different embodiments of the present invention.

Of note, where a continuous data request from host 210 to tiered non-volatile memory 220 is received, controller circuit 235 can cause solid state, non-volatile storage 230 to be bypassed. This bypass may be accomplished by buffering data between single dimensional hard disk storage 240 and host 210 using a buffer 250. Buffer 250 may be any memory device known in the art. For example, buffer 250 may be a random access, volatile, solid state memory of sufficient size to buffer a transfer block desired by single dimensional hard disk storage 240. Thus, for example, where single dimensional hard disk storage transfers 4096 bytes per access, buffer 250 may be 8192 byes. Transfer to/from buffer 250 and single dimensional hard disk storage 240 is controlled by controller circuit 235. As an example, where multiple sectors of data are to be read by host 210 and none of the sectors are included in solid state, non-volatile storage 230, controller circuit 235 may direct single dimensional hard disk storage 240 to support the read directly without passing data through solid state, non-volatile storage 230. Such an approach avoids unnecessary writes to solid state, non-volatile storage 230 which reduce its lifecycle. Where some of the data exists in solid state, non-volatile storage 230 and is updated in comparison with the data maintained on single dimensional hard disk storage 240, a write back from solid state, non-volatile storage 230 to single dimensional hard disk storage 240 may be triggered prior to starting the block transfer from single dimensional hard disk storage 240. Based upon this discussion, one of ordinary skill in the art will recognize other bypass approaches that may be employed in accordance with different embodiments of the present invention to avoid unnecessary writes to solid state, non-volatile storage 230.

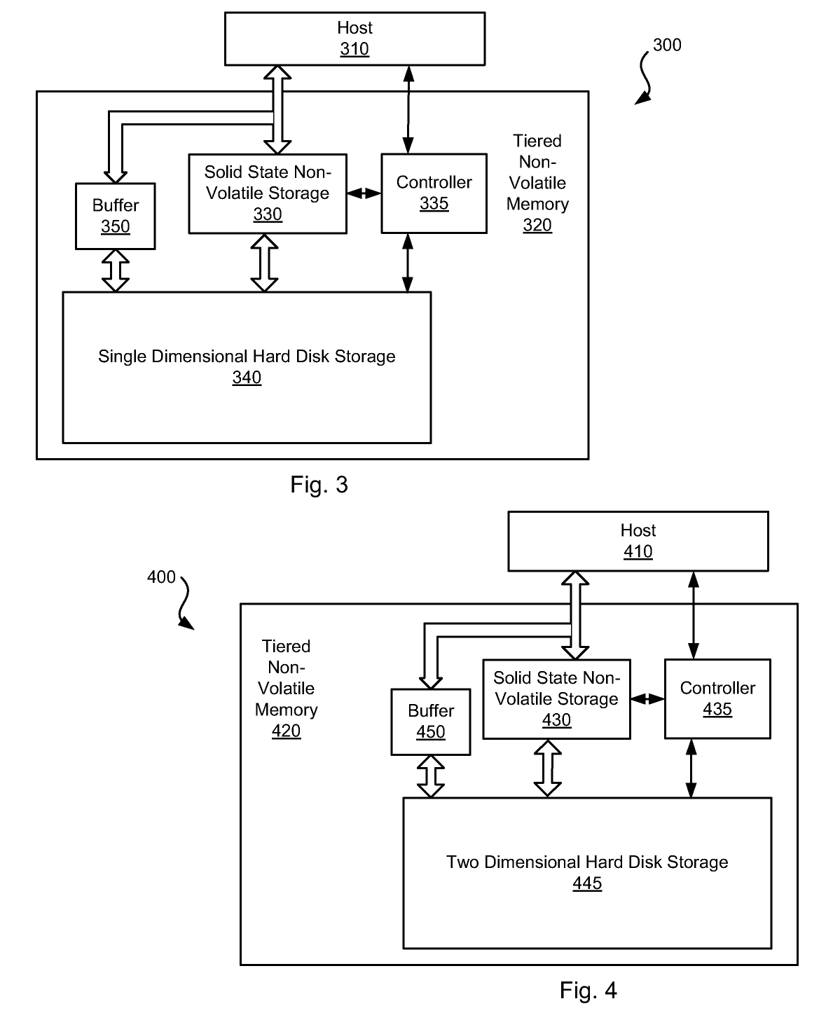

Turning to FIG. 3, a system 300 including a tiered non-volatile memory 320 communicably coupled to a host 310 is shown in accordance with one or more embodiments of the present invention. Host 310 may be any device or system capable of transferring data to and from a storage device. Thus, host 310 may be, but is not limited to, a microprocessor, a computer based system, or an interface circuit as are known in the art. Based upon the disclosure provided herein, one of ordinary skill in the art will recognize a variety of devices and/or systems that may serve as a host in accordance with different embodiments of the present invention.

Tiered non-volatile memory 320 includes two tiers of memory. Specifically, tiered non-volatile memory 320 includes a first tier comprising a solid state, non-volatile storage 330 and a second tier comprising a single dimensional hard disk storage 340. Solid state, non-volatile storage 330 may be implemented using any solid state memory technology known in the art. Thus, solid state, non-volatile storage 330 may be implemented using, but is not limited to, flash memory, phase change memory, spin-torque memory, ferroelectric memory, magnetic memory, resistive memory, racetrack memory, oxide trap based flash memory, or other non-volatile, solid state memory types known in the art. Solid state, non-volatile storage 330 provides the advantages of fast I/O access, along with other benefits of solid state devices including reduced power and reasonable reliability. Further, solid state, non-volatile storage 330 provides an ability to translate long and short memory accesses between host 310 and tiered non-volatile memory 320.

Single dimensional hard disk storage 340 is a hard disk where the track width is substantially the same width as a write head used for writing data from the disk. Single dimensional hard disk storage 340 may include relatively long sectors of data. Such sectors may be much longer than the access block supported by host 310. For example, such sectors may be 4096 bytes in length, whereas the access length supported by host 310 may only be 512 bytes. Further, single dimensional hard disk storage 340 typically offers lower cost per bit compared with solid state, non-volatile memories, but at increased access latency.

In some embodiments of the present invention, solid state, non-volatile storage 330 operates as a cache to single dimensional hard disk storage 340. Caching between the two levels is governed by a controller circuit 335. Such caching provides an advantage of being able to mask the latency of a read/modify/write instruction from host 310. Said another way, while a read/modify write process may in some cases still be performed between solid state, non-volatile storage 330 and single dimensional hard disk storage 340, the latency caused by such a process is masked from host 310. Alternatively, in some cases solid state, non-volatile storage 330 may include entire sectors (or larger blocks of data) pulled from single dimensional hard disk storage 340, and allow for overwriting only a portion of a given sector. When solid state, non-volatile memory 330 is full and an address is accessed that is not included in solid state, non-volatile memory 330, a cache miss occurs. Such a cache miss causes a write back of at least a sector of data from solid state, non-volatile storage 330 to single dimensional hard disk storage 340 (or an invalidation of a sector of data in solid state, non-volatile storage 330), and a read of a sector of data from single dimensional hard disk storage 340 that includes the address to be accessed. It should be noted that any cache miss support approach and/or cache replacement scheme known in the art may be used to determine whether a cache miss has occurred, and to transfer data between different levels of the cache. As just some other advantages, a lower active duty cycle for tiered non-volatile storage 320 may be used where such a caching scheme is employed. Yet further, because the latency of the read/modify/write process is masked from host 310, the hard disks in single dimensional hard disk storage 340 may operate at a much lower rate of revolution.

In one particular embodiment of the present invention, single dimensional hard disk storage 340 is fifty times larger than solid state, non-volatile storage 330. Based upon the disclosure provided herein, one of ordinary skill in the art will recognize a variety of different ratios between solid state, non-volatile storage 330 and single dimensional hard disk storage 340. In one particular embodiment of the present invention, single dimensional hard disk storage 340 is one terabyte, and solid state, non-volatile storage is five gigabytes. Based upon the disclosure provided herein, one of ordinary skill in the art will recognize a variety of memory sizes that can be used for each of single dimensional hard disk storage and solid state, non-volatile storage in accordance with different embodiments of the present invention.

Of note, where a continuous data request from host 310 to tiered non-volatile memory 320 is received, controller circuit 335 can cause solid state, non-volatile storage 330 to be bypassed. This bypass may be accomplished by buffering data between single dimensional hard disk storage 340 and host 310 using a buffer 350. Buffer 350 may be any memory device known in the art. For example, buffer 350 may be a random access, volatile, solid state memory of sufficient size to buffer a transfer block desired by single dimensional hard disk storage 340. Thus, for example, where single dimensional hard disk storage transfers 4096 bytes per access, buffer 350 may be 4096 byes. Transfer to/from buffer 350 and single dimensional hard disk storage 340 is controlled by controller circuit 335. As an example, where multiple sectors of data are to be read by host 310 and none of the sectors are included in solid state, non-volatile storage 330, controller circuit 335 may direct single dimensional hard disk storage 340 to support the read directly without passing data through solid state, non-volatile storage 330. Such an approach avoids unnecessary writes to solid state, non-volatile storage 330 which reduce its lifecycle. Where some of the data exists in solid state, non-volatile storage 330 and is updated in comparison with the data maintained on single dimensional hard disk storage 340, a write back from solid state, non-volatile storage 330 to single dimensional hard disk storage 340 may be triggered prior to starting the block transfer from single dimensional hard disk storage 340. Based upon this discussion, one of ordinary skill in the art will recognize other bypass approaches that may be employed in accordance with different embodiments of the present invention to avoid unnecessary writes to solid state, non-volatile storage 330.

Turning to FIG. 4, a system 400 including a tiered non-volatile memory 420 communicably coupled to a host 410 is shown in accordance with one or more embodiments of the present invention. Host 410 may be any device or system capable of transferring data to and from a storage device. Thus, host 410 may be, but is not limited to, a microprocessor, a computer based system, or an interface circuit as are known in the art. Based upon the disclosure provided herein, one of ordinary skill in the art will recognize a variety of devices and/or systems that may serve as a host in accordance with different embodiments of the present invention.

Tiered non-volatile memory 420 includes two tiers of memory. Specifically, tiered non-volatile memory 420 includes a first tier comprising a solid state, non-volatile storage 430 and a second tier comprising a two dimensional hard disk storage 345. Solid state, non-volatile storage 430 may be implemented using any solid state memory technology known in the art. Thus, solid state, non-volatile storage 430 may be implemented using, but is not limited to, flash memory, phase change memory, spin-torque memory, ferroelectric memory, magnetic memory, resistive memory, racetrack memory, oxide trap based flash memory, or other non-volatile, solid state memory types known in the art. Solid state, non-volatile storage 430 provides the advantages of fast I/O access, along with other benefits of solid state devices including reduced power and reasonable reliability. Further, solid state, non-volatile storage 430 provides an ability to translate long and short memory accesses between host 410 and tiered non-volatile memory 420.

Two dimensional hard disk storage 445 is a hard disk where the track width is less than the width of a write head used for writing data from the disk. By offering track widths that are less than the width a write width, two dimensional hard disk storage 445 can offer increased areal density, and as such decrease the cost per bit of storage. Such an approach generally relies on powerful codes that span multiple tracks. While offering increased bit density, relatively slow I/O rates are supported. However, these slow access times may be hidden on average by the access through solid state, non-volatile storage 430.

In some embodiments of the present invention, solid state, non-volatile storage 430 operates as a cache to two dimensional hard disk storage 445. Caching between the two levels of cache is governed by a controller circuit 435. Such caching provides an advantage of being able to mask the latency of a read/modify/write instruction from host 410. Said another way, while a read/modify write process may in some cases still be performed between solid state, non-volatile storage 430 and two dimensional hard disk storage 445, the latency caused by such a process is masked from host 410. Alternatively, in some cases solid state, non-volatile storage 430 may include entire sectors (or larger blocks of data) pulled from single dimensional hard disk storage 440, and allow for overwriting only a portion of a given sector. When solid state, non-volatile memory 430 is full and an address is accessed that is not included in solid state, non-volatile memory 430, a cache miss occurs. Such a cache miss causes a write back of at least a sector of data from solid state, non-volatile storage 430 to two dimensional hard disk storage 445 (or an invalidation of a sector of data in solid state, non-volatile storage 430), and a read of at least the sector of data from two dimensional hard disk storage 445 that includes the address to be accessed. It should be noted that any cache miss support approach and/or cache replacement scheme known in the art may be used to determine whether a cache miss has occurred, and to transfer data between different levels of the cache.

In one particular embodiment of the present invention, two dimensional hard disk storage 445 is fifty times larger than solid state, non-volatile storage 430. Based upon the disclosure provided herein, one of ordinary skill in the art will recognize a variety of different ratios between solid state, non-volatile storage 430 and two dimensional hard disk storage 445. In one particular embodiment of the present invention, two dimensional hard disk storage 445 is two terabytes, and solid state, non-volatile storage is sixteen gigabytes. Based upon the disclosure provided herein, one of ordinary skill in the art will recognize a variety of memory sizes that can be used for each of single dimensional hard disk storage and solid state, non-volatile storage in accordance with different embodiments of the present invention.

Of note, where a continuous data request from host 410 to tiered non-volatile memory 420 is received, controller circuit 435 can cause solid state, non-volatile storage 430 to be bypassed. This bypass may be accomplished by buffering data between two dimensional hard disk storage 445 and host 410 using a buffer 450. Buffer 450 may be any memory device known in the art. For example, buffer 450 may be a random access, volatile, solid state memory of sufficient size to buffer a transfer block desired by two dimensional hard disk storage 445. Thus, for example, where two dimensional hard disk storage transfers 32K bytes per access, buffer 450 may be 64K byes. Transfer to/from buffer 450 and two dimensional hard disk storage 445 is controlled by controller circuit 435. As an example, where multiple sectors of data are to be read by host 410 and none of the sectors are included in solid state, non-volatile storage 430, controller circuit 435 may direct two dimensional hard disk storage 445 to support the read directly without passing data through solid state, non-volatile storage 430. Such an approach avoids unnecessary writes to solid state, non-volatile storage 430 which reduce its lifecycle. Where some of the data exists in solid state, non-volatile storage 430 and is updated in comparison with the data maintained on two dimensional hard disk storage 445, a write back from solid state, non-volatile storage 430 to two dimensional hard disk storage 445 may be triggered prior to starting the block transfer from two dimensional hard disk storage 445. Based upon this discussion, one of ordinary skill in the art will recognize other bypass approaches that may be employed in accordance with different embodiments of the present invention to avoid unnecessary writes to solid state, non-volatile storage 430.

Turning to FIG. 5, a portion 500 of a single dimensional hard disk storage device is shown. Portion 500 includes a single track 540 that includes a number of user data regions 525 interspersed by servo data regions 520, 530. A write head 510 is disposed in relation to track 540, and is operational to cause a magnetic pattern to be written to user data region 525 as write head 510 passes over the region. Of note, the width of track 540 is approximately the same as a width 512 of write head 510. It should be noted that track 540 is one of many parallel tracks that are laid out on the surface of a storage medium as is known in the art.

In operation, write head is passed over user data region 525 at a defined rate. During each bit period as write head 510 passes over user data region 525, a different current is passed through write head 510 inducing a magnetic field around write head 510. The magnetic field causes a varying level of magnetization on the surface of the storage medium corresponding to user data region 525. The magnetic field may be sensed later and used to regenerate the data that was originally written to the surface of the storage medium corresponding to user data region 525. Of note, writing a data pattern to user data region involves passing write head over track 540 only a single time.

Turning to FIG. 6, a portion 600 of a two dimensional hard disk storage device is shown. Portion 600 includes multiple tracks 640 each including a respective user data region 625, 627, 629 interspersed by servo data regions 620, 622, 624, 630, 632, 634, respectively. A write head 610 is disposed in relation to multiple tracks 640, and is operational to cause a magnetic pattern to be written to user tow or more of data regions 625, 627, 629 as write head 610 passes over the respective regions. Of note, the width of any of the individual tracks of multiple tracks 640 (i.e., track width 614, track width 616 and track width 618) are each substantially less than a width 612 of write head 610. It should be noted that the individual tracks of multiple tracks 640 are just some of many parallel tracks that are laid out on the surface of a storage medium as is known in the art. It should be noted that while write head 610 is shown as approximately two times the width of any given track that other embodiments may use a write head and tracks that exhibits widths that are in different proportion to one another.

Use of such a two dimensional hard disk storage is more fully described in relation to FIGS. 7a-7c. Turning to FIG. 7a, write head 610 is passed over the first two tracks including user data region 725 and user data region 727. During each bit period as write head 610 passes over user data region 725 and user data region 727, a different current is passed through write head 610 inducing a magnetic field around write head 610. The magnetic field causes a varying level of magnetization on the surface of the storage medium corresponding to user data region 725 and user data region 727. This results in writing the same “first write user data” to both user data region 725 and user data region 727.

As shown in FIG. 7b, write head 610 is subsequently moved such that it flies over user data region 727 and user data region 729 at the same time. During each bit period as write head 610 passes over user data region 727 and user data region 729, a different current is passed through write head 610 inducing a magnetic field around write head 610. The magnetic field causes a varying level of magnetization on the surface of the storage medium corresponding to user data region 727 and user data region 729. This results in writing the same “second write user data” to both user data region 727 and user data region 729. Of note, user data region 727 that previously was written with first write user data is overwritten with second write user data.

As shown in FIG. 7c, the process continues by moving write head 610 such that it flies over user data region 729 and user data region 731 at the same time. During each bit period as write head 610 passes over user data region 729 and user data region 731, a different current is passed through write head 610 inducing a magnetic field around write head 610. The magnetic field causes a varying level of magnetization on the surface of the storage medium corresponding to user data region 729 and user data region 731. This results in writing the same “third write user data” to both user data region 729 and user data region 731. Of note, user data region 729 that previously was written with second write user data is overwritten with third write user data.

The “shingling” effect shown in FIGS. 7a-7c is repeated for a number of tracks that are blocked together. Of note, a very high bit density can be achieved as the previous limit based on the width of write head 610 is removed. It should also be noted that the latency of such shingled writes may be substantially increased when compared with the single dimension track write process discussed above in relation to FIG. 5.

In some embodiments of the present invention, a single dimensional hard disk storage is implemented on a separate device apart from a two dimensional hard disk storage. In other cases, the single dimensional hard disk storage is implemented on the same device as the two dimensional hard disk storage. Turning to FIG. 8, a multi-tiered storage device 800 including a single dimensional hard disk storage implemented on the same device as a two dimensional hard disk storage is shown in accordance with some embodiments of the present invention. In particular, multi-tiered storage device 800 includes a solid state, non-volatile storage 890. An interface controller 820 provides control for accessing a disk platter 878 as either a single dimensional hard disk storage access or a two dimensional hard disk storage access. Multi-tiered storage device 800 also includes a preamplifier 870, a hard disk controller 866, a motor controller 868, a spindle motor 872, and a read/write head 876. Interface controller 820 controls addressing and timing of data to/from disk platter 878. The data on disk platter 878 consists of groups of magnetic signals that may be detected by read/write head assembly 876 when the assembly is properly positioned over disk platter 878. In one embodiment, disk platter 878 includes magnetic signals recorded in accordance with either a longitudinal or a perpendicular recording scheme. Again, the data stored on disk platter 878 may be written in accordance with either a single dimensional storage device similar to that discussed above in relation to FIG. 5, or a two dimensional storage device similar to that discussed above in relation to FIGS. 6-7.

In a typical write operation, it is determined whether the address to be written is included in solid state, non-volatile storage 890. Where it is included in solid state, non-volatile storage 890, interface controller 820 causes write data 802 from a host (not shown) to be written to the appropriate address in solid state, non-volatile storage 890. On the other hand, where the address is not included in solid state, non-volatile storage 890, but is included on a single dimensional portion of disk platter 878, read/write head assembly 876 is accurately positioned by motor controller 868 over a desired data track on disk platter 878. Motor controller 868 both positions read/write head assembly 876 in relation to disk platter 878 and drives spindle motor 872 by moving read/write head assembly to the proper data track on disk platter 878 under the direction of hard disk controller 866. Spindle motor 872 spins disk platter 878 at a determined spin rate (RPMs). Once read/write head assembly 878 is positioned adjacent the proper data track, magnetic signals representing data on disk platter 878 are sensed by read/write head assembly 876 as disk platter 878 is rotated by spindle motor 872. The sensed magnetic signals are provided as a continuous, minute analog signal representative of the magnetic data on disk platter 878. This minute analog signal is transferred from read/write head assembly 876 to read channel module 864 via preamplifier 870. Preamplifier 870 is operable to amplify the minute analog signals accessed from disk platter 878. In turn, read channel module 810 decodes and digitizes the received analog signal to recreate the information originally written to disk platter 878. This data is provided as read data 805 to solid state, non-volatile storage 890 where it is cached. In turn, solid state, non-volatile storage 890 overwrites a portion of the data recently stored to solid state, non-volatile storage 890 corresponding to write data 802. This write data 802 remains on solid state, non-volatile storage 890 until it is flushed from solid state, non-volatile storage 890 to disk platter according to a cache replacement policy employed by multi-tiered storage device 800.

In contrast, where the data is also not available on the single dimensional portion of disk platter 878, a large block of data encompassing the address to be written can be read from the two dimensional portion of disk platter 878 and written to the single dimensional portion of disk platter 878 displacing data previously maintained on the single dimensional portion of disk platter 878 in accordance with a cache replacement algorithm. A subset of the block may then be transferred to solid state, non-volatile storage 890 via read data 805. The portion to be written is then modified in solid state, non-volatile storage 890 where it remains until it is flushed from solid state, non-volatile storage 890 to disk platter according to a cache replacement policy employed by multi-tiered storage device 800.

Read transfers are accomplished in similar fashion. Further, where a large transfer from the host is to be written and the data is not in solid state, non-volatile storage 890, the write can bypass solid state, non-volatile storage 890 and instead be written directly as write data 807 to disk platter 878 via read channel circuit 810. This may be done using a specialized instruction from the host that is recognized by interface controller circuit 820. Such an approach may be used to limit wear on solid state, non-volatile storage 890, and thereby extend the lifecycle thereof. Similarly, when a large read request is requested by the host and the data is not in solid state, non-volatile storage 890, the read request can bypass solid state, non-volatile storage 890 and instead be read directly as read data 803 from disk platter 878 via read channel circuit 810. This may be done using a specialized instruction from the host that is recognized by interface controller circuit 820. Such an approach may be used to limit wear on solid state, non-volatile storage 890, and thereby extend the lifecycle thereof.

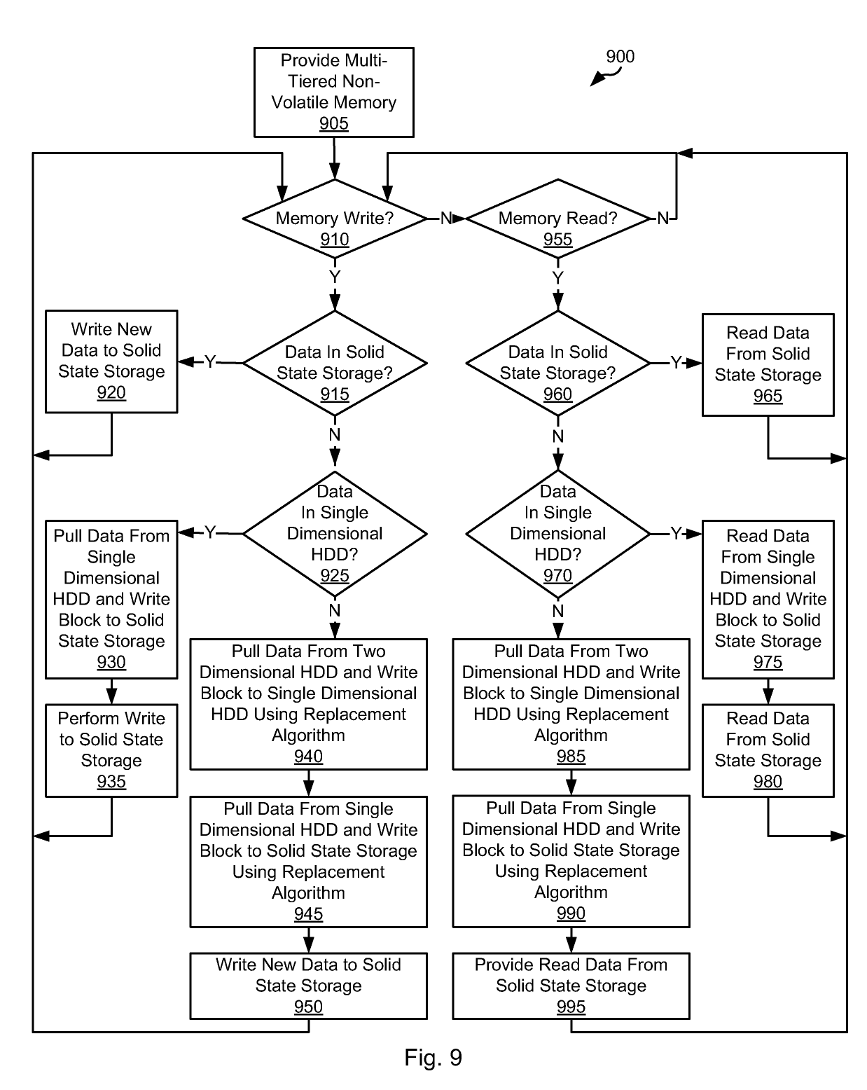

Turning to FIG. 9, a flow diagram 900 shows a method in accordance with some embodiments of the present invention for storing data in relation to a tiered non-volatile storage device. Following flow diagram 905, a multi-tiered non-volatile memory is provided (block 905). It is determined whether a memory write request (block 910) or a memory read request (block 955) is received from a host. Such memory write requests and memory read requests may be any request types known in the art. As an example, the memory write requests identify a beginning address from which data is to be written, and a length of the data to be written. In some cases, such writes are done on a block basis. Similarly, the memory read requests identify a beginning address from which data is to be read, and a length of the data to be written. In some cases, such writes and reads are done on a block basis. As an example, the block may be 512 bytes.

Where a memory write request is received (block 910), it is determined whether the address space to be written is stored in the solid state storage (block 915). Where the address space to be written is stored in the solid state storage (block 915), the new data is written to the solid state storage (block 920), and the write process completes.

Alternatively, where the address space to be written is not included in the solid state storage (block 915), it is determined whether the address space to be written is stored in the single dimensional hard disk (block 925). Where the address space to be written is stored in the single dimensional hard disk (block 925), a data block including the address space to be written is read from the single dimensional hard disk and written to solid state storage (block 930). This includes replacing a block in the solid state storage. Such replacement may be done in accordance with any cache replacement algorithm known in the art. The new data is then written to the solid state storage (block 935), and the write process completes.

Alternatively, where the address space to be written is not included in the single dimensional hard disk (block 925), a data block including the address space to be written is read from the two dimensional hard disk and written to the single dimensional hard disk (block 940). This includes replacing a block in the single dimensional hard disk. Such replacement may be done in accordance with any cache replacement algorithm known in the art. In addition, a data block including the address space to be written is read from the single dimensional hard disk and written to the solid state storage (block 945). This includes replacing a block in the solid state storage. Such replacement may be done in accordance with any cache replacement algorithm known in the art. The new data is then written to the solid state storage (block 950), and the write process completes.

Where, on the other hand, a memory read request is received (block 955), it is determined whether the address space to be read is stored in the solid state storage (block 960). Where the address space to be read is stored in the solid state storage (block 960), the new data is read from the solid state storage (block 965), and the read process completes.

Alternatively, where the address space to be read is not included in the solid state storage (block 960), it is determined whether the address space to be read is stored in the single dimensional hard disk (block 970). Where the address space to be read is stored in the single dimensional hard disk (block 970), a data block including the address space to be read is read from the single dimensional hard disk and written to solid state storage (block 975). This includes replacing a block in the solid state storage. Such replacement may be done in accordance with any cache replacement algorithm known in the art. The new data is then read from to the solid state storage (block 980), and the read process completes. It should be noted that in some cases, the read data may be passed directly to the host from the single dimensional hard disk in parallel with the write to the solid state storage. This reduces the read latency incurred during a cache miss.

Alternatively, where the address space to be read is not included in the single dimensional hard disk (block 970), a data block including the address space to be read is read from the two dimensional hard disk and written to the single dimensional hard disk (block 985). This includes replacing a block in the single dimensional hard disk. Such replacement may be done in accordance with any cache replacement algorithm known in the art. In addition, a data block including the address space to be read is read from the single dimensional hard disk and written to the solid state storage (block 990). This includes replacing a block in the solid state storage. Such replacement may be done in accordance with any cache replacement algorithm known in the art. The data is then read from the solid state storage (block 995), and the write process completes. It should be noted that in some cases, the read data may be passed directly to the host from the two dimensional hard disk in parallel with the write to the single dimensional hard disk, or directly from the single dimensional hard disk in parallel with the write to the solid state storage. This reduces the read latency incurred during a cache miss.

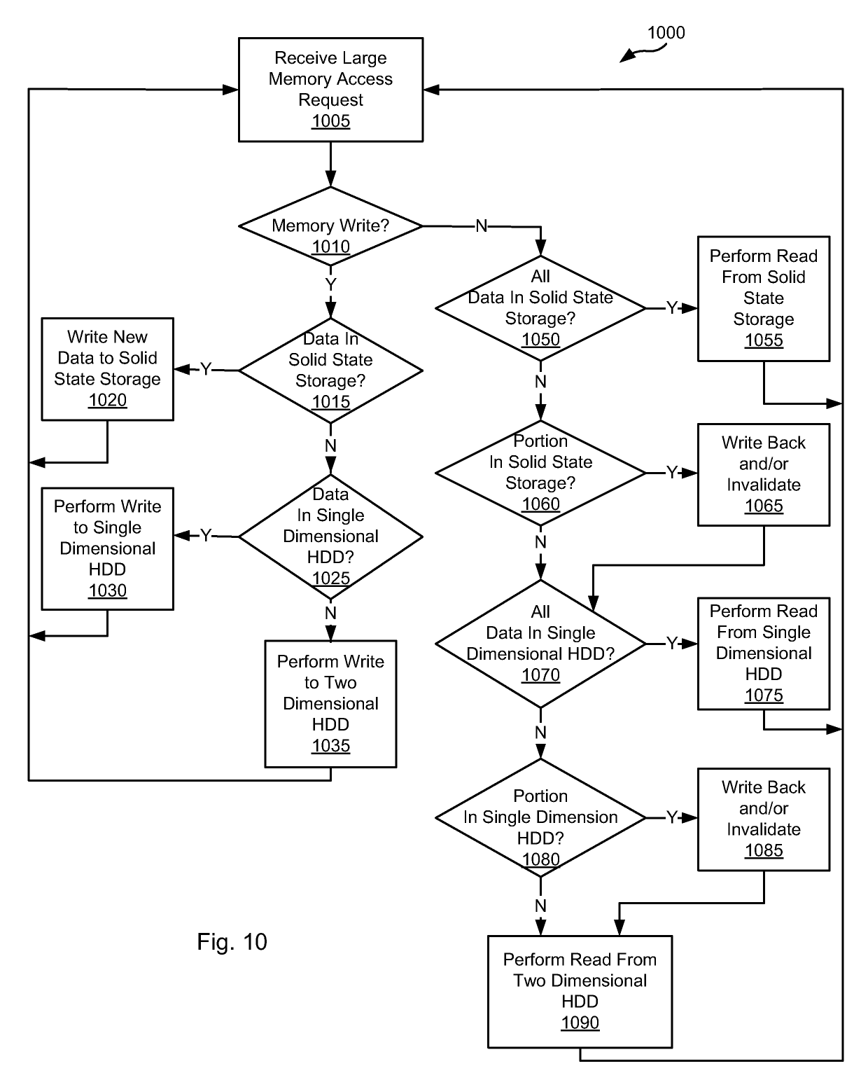

Turning to FIG. 10, a flow diagram 1000 shows a method in accordance with one or more embodiments of the present invention for bypassing an upper tier, solid state, non-volatile storage. Following flow diagram 1000, a large memory request is received from a host (block 1005). A memory request may be considered large where it is, for example larger than the size of a solid state storage. As another example, a memory request may be considered large where it is, for example mare than a defined size. Based upon the disclosure provided herein, one of ordinary skill in the art will recognize a variety of request sizes that may be considered large.

It is determined whether the memory request is a read request or a write request (block 1010). Such memory write requests and memory read requests may be any request types known in the art. As an example, the memory write requests identify a beginning address from which data is to be written, and a length of the data to be written. In some cases, such writes are done on a block basis. Similarly, the memory read requests identify a beginning address from which data is to be read, and a length of the data to be written. In some cases, such writes and reads are done on a block basis. As an example, the block may be 512 bytes.

Where a memory write request is received (block 1010), it is determined whether the address space to be written is stored in the solid state storage (block 1015). Where the address space to be written is stored in the solid state storage (block 1015), the new data is written to the solid state storage (block 1020), and the write process completes. This may include replacing a portion of the data maintained in the solid state storage. Such replacement may be done in accordance with any cache replacement algorithm known in the art.

Alternatively, where the address space to be written is not included in the solid state storage (block 1015), it is determined whether the address space to be written is included in the single dimensional hard disk (block 1025). Where the address space to be written is stored in the single dimensional hard disk (block 1025), a write to the single dimensional hard disk is performed (block 1030), and the write process completes. This may include replacing a portion of the data maintained on the single dimensional hard disk. Such replacement may be done in accordance with any cache replacement algorithm known in the art. Alternatively, where the address space to be written is not included in the single dimensional hard disk (block 1035), a write to the two dimensional hard disk is performed (block 1035), and the write process completes.

Where, on the other hand, the memory access request is a read access request (block 1010), it is determined whether the entirety of the address space to be read is stored in the solid state storage (block 1050). Where the entirety of the address space to be read is stored in the solid state storage (block 1050), the new data is read from the solid state storage (block 1055), and the read process completes.

Alternatively, where the entirety of the address space to be read is not included in the solid state storage (block 1050), it is determined whether a portion of the address space to be read is stored in the solid state storage (block 1060). Where a portion is stored on the solid state storage (block 1060), the portion is written back to the single dimensional hard disk and/or invalidated on the solid state storage (block 1065). Either where no portion of the address space to be read is stored in the solid state storage (block 1060) or where the write back and/or invalidation has been performed (block 1065), it is determined whether the entirety of the address space to be read is stored on the single dimensional hard disk (block 1070). Where the entirety of the address space to be read is stored on the single dimensional hard disk (block 1070), the read request is performed from the single dimensional hard disk (block 1075), and the read process completes.

Alternatively, where the entirety of the address space to be read is stored on the single dimensional hard disk (block 1070), it is determined whether a portion of the address space is maintained on the single dimensional hard disk (block 1080). Where a portion is stored on the single dimensional hard disk (block 1080), the portion is written back to the two dimensional hard disk and/or invalidated on the single dimensional hard disk (block 1085). Either where no portion of the address space to be read is stored on the single dimensional hard disk (block 1080) or where the write back and/or invalidation has been performed (block 1085),the read is performed from the two dimensional hard disk (block 1090), and the read process completes.

In conclusion, the invention provides novel systems, devices, methods and arrangements for providing storage with multiple tiers. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A multi-tiered non-volatile storage device, the device comprising:
a hard disk storage;
a solid state, non-volatile storage, wherein the solid state, non-volatile storage caches a subset of data included on the hard disk storage; and
a controller circuit, wherein the controller circuit is operable to control data transfer between the solid state, non-volatile storage and the hard disk storage.

2. The device of claim 1, wherein the hard disk storage is selected from a group consisting of: a single dimensional hard disk storage and a two dimensional hard disk storage.

3. The device of claim 1, wherein the hard disk storage includes both a single dimensional hard disk storage and a two dimensional hard disk storage.

4. The device of claim 3, wherein the single dimensional hard disk storage caches a subset of data included on the two dimensional hard disk storage.

5. The device of claim 4, wherein the controller circuit is operable to control data transfer between the solid state, non-volatile storage and the hard disk storage.

6. The device of claim 4, wherein the two dimensional hard disk storage is three times larger than the single dimensional hard disk storage.

7. The device of claim 1, wherein the controller circuit is operable to bypass the solid state, non-volatile storage when performing a multi-block transfer between a host and the hard disk storage.

8. The device of claim 7, wherein the device further comprises:
a buffer, wherein the buffer is operable to store a block of data from the hard disk storage, and to perform a series of sub-block transfers to a requesting host under control of the controller circuit.

9. The device of claim 7, wherein the device further comprises:
a buffer, wherein the buffer is operable to receive a series of sub-block transfers from a host, and to combine the sub-block transfers into a single block transfer to the hard disk storage under control of the controller circuit.

10. The device of claim 1, wherein the hard disk storage is at least an order of magnitude larger than the solid state, non-volatile storage.

11. A method for non-volatile data storage, the method comprising:
providing a multi-tiered, non-volatile memory, wherein the multi-tiered, non-volatile memory includes:
a hard disk storage;
a solid state, non-volatile storage, wherein the solid state, non-volatile storage caches a subset of data included on the hard disk storage; and
a controller circuit, wherein the controller circuit is operable to control data transfer between the solid state, non-volatile storage and the hard disk storage; and
receiving a request from a host to access the multi-tiered, non-volatile memory; and
responding to the request.

12. The method of claim 11, wherein the request is a read request, and wherein responding to the read request includes:
determining whether the address space corresponding to the read request is included in the solid state, non-volatile storage; and
where the address space corresponding to the read request is included in the solid state, non-volatile storage, responding to the read request from the solid state, non-volatile storage.

13. The method of claim 11, wherein the request is a read request, and wherein responding to the read request includes:
determining whether the address space corresponding to the read request is included in the solid state, non-volatile storage;
where the address space corresponding to the read request is not included in the solid state, non-volatile storage, transferring a block of data from the hard disk storage to the solid state, non-volatile storage, wherein the block of data includes the address space corresponding to the read request; and
responding to the read request from the solid state, non-volatile storage.

14. The method of claim 11, wherein the request is an extended read request, and wherein responding to the extended read request includes:
determining whether the address space corresponding to the extended read request is included in the solid state, non-volatile storage; and
where the address space corresponding to the read request is not included in the solid state, non-volatile storage, responding to the extended read request from the hard disk storage without passing through the solid state, non-volatile storage.

15. The method of claim 11, wherein the request is a write request, and wherein responding to the write request includes:
determining whether the address space corresponding to the write request is included in the solid state, non-volatile storage; and
where the address space corresponding to the write request is included in the solid state, non-volatile storage, responding to the write request by writing the data corresponding to the write request to the solid state, non-volatile storage.

16. The method of claim 11, wherein the request is a write request, and wherein responding to the write request includes:
determining whether the address space corresponding to the write request is included in the solid state, non-volatile storage;
where the address space corresponding to the write request is not included in the solid state, non-volatile storage, transferring a block of data from the hard disk storage to the solid state, non-volatile storage, wherein the block of data includes the address space corresponding to the write request; and
responding to the write request by writing the data corresponding to the write request to the solid state, non-volatile storage.

17. The method of claim 11, wherein the request is an extended write request, and wherein responding to the extended write request includes:
determining whether the address space corresponding to the extended write request is included in the solid state, non-volatile storage; and
where the address space corresponding to the extended write request is not included in the solid state, non-volatile storage, responding to the extended write request by writing the data corresponding to the extended write request to the hard disk storage without passing through the solid state, non-volatile storage.

18. The method of claim 11, wherein the request is an extended write request, and wherein responding to the extended write request includes:
determining whether the address space corresponding to the extended write request is included in the solid state, non-volatile storage; and
where the address space corresponding to the extended write request is at least partially included in the solid state, non-volatile storage, responding to the extended write request by invalidating the address space corresponding to the extended write request in the solid state, non-volatile storage, and writing the data corresponding to the extended write request to the hard disk storage without passing through the solid state, non-volatile storage.

19. The method of claim 11, wherein the request is an extended read request, and wherein responding to the extended read request includes:
determining whether the address space corresponding to the extended read request is included in the solid state, non-volatile storage; and
where the address space corresponding to the read request is at least partially included in the solid state, non-volatile storage, responding to the extended read request by writing the address space corresponding to the extended read request from the solid state, non-volatile storage to the hard disk storage, and responding to the extended read request from the hard disk storage without passing through the solid state, non-volatile storage.

20. A non-volatile storage system, the non-volatile storage system comprising:
a hard disk storage, wherein the hard disk storage comprises:
a storage medium; and
an interface controller circuit, wherein the interface controller circuit is operable to control both single dimensional access to the storage medium and two dimensional access to the storage medium; and
a solid state non-volatile storage, wherein the solid state, non-volatile storage caches a subset of data included on the hard disk storage; and
a controller circuit, wherein the controller circuit is operable to control data transfer between the solid state, non-volatile storage and the hard disk storage.
